(19) United States
(12) Patent Application Publication
(10) Pub. No.: US 2011/0188476 A1
(43) Pub. Date: Aug. 4, 2011

(54) WIRELESS COMMUNICATION SYSTEM, WIRELESS BASE STATION, WIRELESS TERMINAL, AND WIRELESS COMMUNICATION METHOD

(75) Inventor: Taro Ootani, Kanagawa (JP)

(73) Assignee: KYOCERA CORPORATION, Kyoto (JP)

(21) Appl. No.: 13/121,599

(22) PCT Filed: Sep. 28, 2009
(86) PCT No.: PCT/JP2009/066798

§ 371 Date: Mar. 29, 2011

(30) Foreign Application Priority Data
Sep. 29, 2008 (JP) 2008-249879

(51) Int. Cl. H04W 36/08

(52) U.S. Cl. 370/331

(57) ABSTRACT

The controller of the wireless base station includes: the handover source down link data transfer unit configured to transfer the down link data from the upper layer network to the handover source wireless base station in a case where a connection destination of the wireless terminal is the handover source wireless base station; and the handover target down link data transfer unit configured to switch a transfer destination of the down link data from the handover source wireless base station to the handover target wireless base station and then transfer the down link data to the handover target wireless base station in a case where the connection destination of the wireless terminal needs to be switched from the handover source wireless base station to the handover target wireless base station, and also where the down link data is specific data.

### TECHNICAL FIELD

The present invention relates to a wireless communication system, a wireless base station, a wireless terminal, and a wireless communication method for transferring down link data between wireless base stations.

### BACKGROUND ART

In a wireless communication system, a wireless terminal in motion or the like conventionally performs so-called handover, which is to switch a connection destination to a wireless base station having a better connection condition.

In such a wireless communication system, a wireless base station (relay wireless base station) functioning as a relay station receives down link data addressed to a wireless terminal from an access gateway in an upper layer network. Before handover, the relay wireless base station transfers the received down link data to a handover origin wireless base station (handover source wireless base station). The handover source wireless base station transmits the received down link data to the wireless terminal.

Meanwhile, after handover, the relay wireless base station transfers the received down link data to the handover source wireless base station as in the situation before handover. The handover source wireless base station transmits the received down link data to a handover destination wireless base station (handover target wireless base station). Furthermore, the handover target wireless base station transmits the received down link data to the wireless terminal. Through the aforementioned processing, the down link data can be seamlessly transmitted to the wireless terminal even after handover.

One of citable examples of the aforementioned wireless communication system is UMB (Ultra Mobile Broadband) which is in the process of standardization in 3GPP2 (Third Generation Partnership Project 2) (refer to Non-Patent Document 1).

### Prior Art Document

### Non-Patent Document

Non-Patent Document 1: “Overview for Ultra Mobile Broadband (UMB) Air Interface Specification (3GPP2 C. S0084-000-0),” [online], [Searched on Sep. 19, 2008], <http://www.3gpp2.org/Public_html/specs/C.S0084-000-0_v2.0_{—}070904.pdf>

### DISCLOSURE OF THE INVENTION

The aforementioned conventional wireless communication system has the following problems, however. Specifically, after handover, down link data is transferred to the handover target wireless base station from the relay wireless base station via the handover source wireless base station. Accordingly, the transfer processing time in the handover source wireless base station is a delay time in the reception of the down link data in the wireless terminal.

In addition, in some transmission of the down link data, each of the handover source wireless base station and the handover target wireless base station encapsulates the down link data by adding a destination header thereto. The processing to add the destination header in the handover source wireless base station causes an increase in the aforementioned transfer processing time, and further causes an increase in the delay time in the reception of the down link data in the wireless terminal.

In this respect, the present invention has been made to address the aforementioned problems, and an objective of the present invention is thus to provide a wireless communication system, a wireless base station, a wireless terminal, and a wireless communication method each capable of reducing the delay time in the reception of the down link data in a wireless terminal during handover.

To address the above problems, the present invention includes the following aspects. Firstly, the first aspect of the present invention is summarized as a wireless communication system comprising: a wireless terminal (wireless terminal 2); a relay wireless base station (wireless base station 1A) configured to relay down link data addressed to the wireless terminal from an upper layer network; a handover source wireless base station (wireless base station 1B) which is a handover origin in a case where a connection destination of the wireless terminal is to be switched, and a handover target wireless base station (wireless base station 1C) which is a handover destination in a case where the connection destination of the wireless terminal is to be switched, wherein the relay wireless base station includes: a handover source down link data transfer unit (handover source down link data transfer unit 202) configured to transfer the down link data from the upper layer network to the handover source wireless base station in a case where the connection destination of the wireless terminal is the handover source wireless base station; and a handover target down link data transfer unit (handover target down link data transfer unit 204) configured to switch a transfer destination of the down link data from the handover source wireless base station to the handover target wireless base station and then to transfer the down link data to the handover target wireless base station in a case where the connection destination of the wireless terminal needs to be switched from the handover source wireless base station to the handover target wireless base station, and also where the down link data is specific data, the handover source wireless base station includes: a handover source down link data receiver (handover source down link data receiver 302) configured to receive the down link data from the relay wireless base station; and a handover source down link data transmitter (handover source down link data transmitter 304) configured to transmit the down link data received by the handover source down link data receiver to the wireless terminal, the handover target wireless base station includes: a handover target down link data receiver (handover target down link data receiver 402) configured to receive the down link data from the relay wireless base station; and a handover target down link data transmitter (handover target down link data transmitter 404) configured to transmit the down link data received by the handover target down link data receiver to the wireless terminal, and the wireless terminal includes a terminal down link data receiver (terminal down link data receiver 502) configured to receive the down link data from at least any of the handover source wireless base station and the handover target wireless base station.

According to the wireless communication system described above, the relay wireless base station configured to relay down link data addressed to the wireless terminal from an upper layer network switches the transfer destination of the down link data from the handover source wireless base station to the handover target wireless base station and then transfers the down link data to the handover target wireless base station in a case where the connection destination of the wireless terminal needs to be switched from the handover source wireless base station to the handover target wireless base station, and the down link data is specific data.

Specifically, the relay wireless base station can directly transfer the down link data to the handover target wireless base station without the need of the handover source wireless base station. Here, since there is no transfer processing in the handover source wireless base station, the delay time in the reception of the down link data in the wireless terminal can be reduced.

A second aspect of the present invention is that the wireless terminal includes a connection switching advance notice transmitter (connection switching advance notice transmitter 504) configured to transmit a connection switching advance notice to the handover source wireless base station, the connection switching advance notice announcing in advance that the connection destination will be switched from the handover source wireless base station to the handover target wireless base station, the handover source wireless base station includes: a switching source connection switching advance notice receiver (switching source connection switching advance notice receiver 306) configured to receive the connection switching advance notice from the wireless terminal; a data determination unit (data determination unit 308) configured to determine whether or not the down link data is the specific data in a case where the switching source connection switching advance notice receiver receives the connection switching advance notice; a connection switching advance notice transfer unit (connection switching advance notice transfer unit 310) configured to transfer the connection switching advance notice received by the switching source connection switching advance notice receiver to the relay wireless base station in a case where the data determination unit determines that the down link data is the specific data; a down link data transmission stopping unit (down link data transmission stopping unit 312) configured to stop transmission of the down link data to the wireless terminal in a case where the data determination unit determines that the down link data is the specific data, the relay wireless base station includes a relay station connection switching advance notice receiver (relay station connection switching advance notice receiver 206) configured to receive the connection switching advance notice from the handover source wireless base station, and the handover target down link data transfer unit switches the transfer destination of the down link data from the handover source wireless base station to the handover target wireless base station and then transfers the down link data to the handover target wireless base station in a case where the relay station connection switching advance notice receiver receives the connection switching advance notice.

A third aspect of the present invention is that the wireless terminal includes a connection switching advance notice transmitter (connection switching advance notice transmitter 504) configured to transmit a connection switching advance notice to the handover source wireless base station, the connection switching advance notice announcing in advance that the connection destination is to be switched from the handover source wireless base station to the handover target wireless base station, the handover source wireless base station includes: a switching source connection switching advance notice receiver (switching source connection switching advance notice receiver 306) configured to receive the connection switching advance notice from the wireless terminal; and a connection switching advance notice transfer unit (connection switching advance notice transfer unit 310) configured to transfer the connection switching advance notice received by the switching source connection switching advance notice receiver to the relay wireless base station, the relay wireless base station includes: a relay station connection switching advance notice receiver (relay station connection switching advance notice receiver 206) configured to receive the connection switching advance notice from the handover source wireless base station; and a data determination unit (data determination unit 208) configured to determine whether or not the down link data is the specific data in a case where the relay station connection switching advance notice receiver receives the connection switching advance notice, and the handover target down link data transfer unit switches the transfer destination of the down link data from the handover source wireless base station to the handover target wireless base station and then transfers the down link data to the handover target wireless base station in a case where the data determination unit determines that the down link data is the specific data.

A fourth aspect of the present invention is that the specific data is data to be handled in real time.

A fifth aspect of the present invention is that the specific data is sound data.

A sixth aspect of the present invention is that the connection switching advance notice includes identification information of the handover target wireless base station and identification information of the down link data already received by the wireless terminal, and the handover target down link data transfer unit transfers the down link data not yet received by the wireless terminal to the handover target wireless base station on the basis of the identification information of the handover target wireless base station and the identification information of the down link data already received by the wireless terminal.

A seventh aspect of the present invention is summarized as a wireless base station (wireless base station 1A) configured to transmit down link data addressed to a wireless terminal (wireless terminal 2) from an upper layer network to the wireless terminal via a handover source wireless base station (handover source wireless base station 1B) and a handover target wireless base station (handover target wireless base station 1C) which are other wireless base stations to connect to the wireless terminal, the wireless base station comprising: a handover source down link data transfer unit (handover source down link data transfer unit 202) configured to transfer the down link data from the upper layer network to the handover source wireless base station in a case where a connection destination of the wireless terminal is the handover source wireless base station; and a handover target down link data transfer unit (handover target down link data transfer unit 204) configured to switch a transfer destination of the down link data from the handover source wireless base station to the handover target wireless base station and then transfer the down link data to the handover target wireless base station in a case where the connection destination of the wireless terminal needs to be switched from the handover source wireless base station to the handover target wireless base station, and also where the down link data is specific data.

A eighth aspect of the present invention is summarized as a wireless base station (wireless base station 1B) which is configured to perform communication with a wireless terminal (wireless terminal 2) and which is a handover origin in a case where a connection destination of the wireless terminal is to be switched, the wireless base station comprising: a handover source down link data receiver (handover source down link data receiver 302) configured to receive down link data addressed to the wireless terminal and transmitted from an upper layer network via a relay wireless base station (wireless base station 1A) which is another wireless base station; a handover source down link data transmitter (handover source down link data transmitter 304) configured to transmit the down link data received by the handover source down link data receiver to the wireless terminal; a switching source connection switching advance notice receiver (switching source connection switching advance notice receiver 306) configured to receive a connection switching advance notice from the wireless terminal, the connection switching advance notice announcing in advance that the connection destination of the wireless terminal will be switched to a handover target wireless base station which is another wireless base station; a data determination unit (data determination unit 308) configured to determine whether the down link data is the specific data in case where the switching source connection switching advance notice receiver receives the connection switching advance notice; a connection switching advance notice transfer unit (connection switching advance notice transfer unit 310) configured to transfer the connection switching advance notice to the relay wireless base station in a case where the data determination unit determines that the down link data is the specific data; and a down link data transmission stopping unit (down link data transmission stopping unit 312) configured to stop transmission of the down link data to the wireless terminal in a case where the data determination unit determines that the down link data is the specific data.

A ninth aspect of the present invention is summarized as a wireless base station (wireless base station 1B) which is configured to perform communication with a wireless terminal (wireless terminal 2) and which is a handover origin in a case where a connection destination of the wireless terminal is to be switched, the wireless base station comprising: a handover source down link data receiver (handover source down link data receiver 302) configured to receive down link data addressed to the wireless terminal and transmitted from an upper layer network via a relay wireless base station (wireless base station 1A) which is another wireless base station; a handover source down link data transmitter (handover source down link data transmitter 304) configured to transmit the down link data received by the handover source down link data receiver to the wireless terminal; a switching source connection switching advance notice receiver (switching source connection switching advance notice receiver 306) configured to receive a connection switching advance notice from the wireless terminal, the connection switching advance notice announcing in advance that the connection destination of the wireless terminal will be switched to a handover target wireless base station which is another wireless base station; a connection switching advance notice transfer unit (connection switching advance notice transfer unit 310) configured to transfer the connection switching advance notice received by the switching source connection switching advance notice receiver to the relay wireless base station; and a down link data transmission stopping unit (down link data transmission stopping unit 312) configured to stop transmission of the down link data to the wireless terminal in a case where the connection switching advance notice transfer unit transfers the connection switching advance notice.

A tenth aspect of the present invention is summarized as a wireless terminal (wireless terminal 2) configured to connect to a wireless base station (wireless base station 1B and 1C) transmitting down link data transferred from an upper layer network via another wireless base station and to perform communication with the wireless base station in connection, the wireless terminal comprising: a terminal down link data receiver (terminal down link data receiver 502) configured to receive the down link data from the wireless base station; and a connection switching advance notice transmitter configured (connection switching advance notice transmitter 504) to transmit a connection switching advance notice to the wireless base station, the connection switching advance notice requesting switching of a connection destination, wherein the connection switching advance notice includes identification information of the handover target wireless base station and identification information of the down link data already received by the wireless terminal.

A eleventh aspect of the present invention is summarized as a wireless communication method in a wireless communication system including: a wireless terminal; a relay wireless base station configured to relay down link data addressed to the wireless terminal from an upper layer network; a handover source wireless base station which is a handover origin in a case where a connection destination of the wireless terminal is to be switched; and a handover target wireless base station which is a handover destination in a case where the connection destination of the wireless terminal is to be switched, the method comprising the steps of: transferring, by the relay wireless base station, the down link data from the upper layer network to the handover source wireless base station in a case where the connection destination of the wireless terminal is the handover source wireless base station (step S101); switching, by the relay wireless base station, a transfer destination of the down link data from the handover source wireless base station to the handover target wireless base station and then to transfer the down link data to the handover target wireless base station in a case where the connection destination of the wireless terminal needs to be switched from the handover source wireless base station to the handover target wireless base station, and also where the down link data is specific data (step S109); receiving, by the handover source wireless base station, the down link data from the relay wireless base station (step S101); transmitting, by the handover source wireless base station, the received down link data to the wireless terminal (step S102); receiving, by the handover target wireless base station, the down link data from the relay wireless base station (step S109); transmitting, by the handover target wireless base station, the received down link data to the wireless terminal (step S110); and receiving, by the wireless terminal, the down link data from at least any of the handover source wireless base station and the handover target wireless base station(step S102, step S110).

According to the present invention, it is possible to provide a wireless communication system, a wireless base station, a wireless terminal, and a wireless communication method each capable of reducing a delay time in reception of down link data in a wireless terminal.

### BRIEF DESCRIPTION OF THE DRAWINGS

FIG. 1 is an overall schematic configuration diagram of a wireless communication system according to a first embodiment of the present invention.

FIG. 2 is a schematic configuration diagram of a wireless base station according to the first embodiment of the present invention.

FIG. 3 is a functional block configuration diagram of a controller in a wireless base station according to the first embodiment of the present invention, the wireless base station being a DAP.

FIG. 4 is a functional block configuration diagram of a controller in a wireless base station according to the first embodiment of the present invention, the wireless base station being a Source FLSE.

FIG. 5 is a functional block configuration diagram of a controller in a wireless base station according to the first embodiment of the present invention, the wireless base station being a Target FLSE.

FIG. 6 is a schematic configuration diagram of a wireless terminal according to the first embodiment of the present invention.

FIG. 7 is a functional block configuration diagram of a controller in the wireless terminal according to the first embodiment of the present invention.

FIG. 8 is a sequence diagram showing an operation of the wireless communication system according to the first embodiment of the present invention.

FIG. 9 is a sequence diagram showing an operation of a conventional wireless communication system.

FIG. 10 is a functional block configuration diagram of a controller in a wireless base station according to a second embodiment of the present invention, the wireless base station being a DAP.

FIG. 11 is a functional block configuration diagram of a controller in a wireless base station according to the second embodiment of the present invention, the wireless base station being a Source FLSE.

FIG. 12 is a sequence diagram showing an operation of a wireless communication system according to the second embodiment of the present invention.

FIG. 13 is an overall schematic configuration diagram of a wireless communication system according to a modification example of the embodiments of the present invention.

FIG. 14 is a sequence diagram showing an operation of the wireless communication system according to the modification example of the embodiments of the present invention.

### BEST MODE FOR CARRYING OUT THE INVENTION

### First Embodiment

Next, a first embodiment of the present invention will be described with reference to the drawings. Specifically, a description will be given of (1) Configuration of Wireless Communication System, (2) Operation of Wireless Communication System, (3) Advantages and Effects, and (4) Other Embodiments. In the description of the drawings in the embodiments to be described below, the same or similar portions are denoted by the same or similar reference numerals.

### (1) Configuration of Wireless Communication System

To begin with, a description will be given of a configuration of a wireless communication system according to the first embodiment in the order of (1.1) Overall Schematic Configuration of Wireless Communication System, (1.2) Configuration of Wireless Base Station, and (1.3) Configuration of Wireless Terminal.

### (1.1) Overall Schematic Configuration of Wireless Communication System

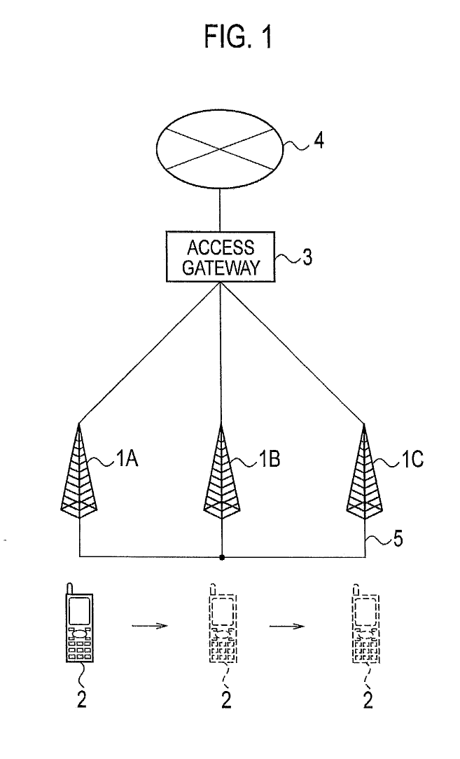

FIG. 1 is an overall schematic configuration diagram of a wireless communication system 10 according to the first embodiment.

As shown in FIG. 1, the wireless communication system 10 includes a wireless base station 1A, a wireless base station 1B, a wireless base station 1C, a wireless terminal 2, an access gateway 3, an upper layer network 4, and a wired network 5. FIG. 1 illustrates only one wireless terminal for simplicity of the description, but a large number of wireless terminals are actually positioned around the wireless base stations 1A to 1C.

In the first embodiment, the wireless communication system 10 has a configuration based on 3GPP2 UMB Air Interface (hereinafter, simply referred to as a “UMB system”), which is one of wide area IP broadband systems capable of performing high-speed communication.

The wireless base stations 1A to 1C and the access gateway 3 are wire-connected to each other via a router or the like, which is not illustrated herein. The wireless base stations 1A to 1C can communicate with the upper layer network 4 via the access gateway 3. In addition, the wireless base stations 1A to 1C can communicate with each other (i.e., communication between the base stations) via the wired network 5.

Each of the wireless base stations 1A to 1C performs wireless communication with a wireless terminal positioned within a communicable area of a corresponding one of the wireless base stations. The wireless terminal 2 compares reception qualities such as reception SNR, reception RSSI, or reception FER of wireless signals (so-called pilot signals) broadcasted respectively by the wireless base stations 1A to 1C when power is turned on or handover is to be performed. The wireless terminal 2 then transmits a connection request to a wireless base station offering the highest reception quality. Such a connection request is called a Route Open message in a UMB system.

In the example shown in FIG. 1, the wireless terminal 2 is moving at a high speed and executes handover from the wireless base station 1A to the wireless base station 1B. In this event, the wireless base station 1A serves as a relay station between the access gateway 3 and the wireless base station 1B and transfers down link data addressed to the wireless terminal 2 to the wireless base station 1B. The wireless base station 1B transmits the down link data received from the wireless base station 1A to the wireless terminal 2.

Further, the wireless terminal 2 executes handover from the wireless base station 1B to the wireless base station 1C. In this event, the wireless base station 1A serves as a relay station between the access gateway 3 and the wireless base station 1C and directly transfers the down link data addressed to the wireless terminal 2 to the wireless base station 1C without the need of the wireless base station 1B. The wireless base station 1C transmits the down link data received from the wireless base station 1A to the wireless terminal 2. Thus, high-speed handover with less data loss is achieved.

Meanwhile, in up link communication, the wireless base stations 1B and 1C transfer up link data received from the wireless terminal 2 to the wireless base station 1A. The wireless base station 1A transmits the up link data received from the wireless base stations 1B and 1C to the access gateway 3.

In the UMB system, a wireless base station functioning as a relay station between the upper layer network 4 and the wireless base stations 1B and 1C (relay wireless base station) like the wireless base station 1A is termed as a DAP (Data Attachment Point). In addition, a wireless base station serving as a handover origin (handover source) and actually transmitting down link data to the wireless terminal 2 (handover source wireless base station) like the wireless base station 1B during the handover from the wireless base station 1B to the wireless base station 1C is termed as a Source FLSE (Down Link Serving eBS). Moreover, a wireless base station serving as a handover destination (switching destination) and actually transmitting down link data to the wireless terminal 2 (handover target wireless base station) like the wireless base station 1C during the handover from the wireless base station 1B to the wireless base station 1C is termed as a Target FLSE.

Further, a wireless base station actually receiving up link data from the wireless terminal 2 is termed as an RLSE (Up Link Serving eBS). Here, the FLSE and the RLSE may be the same or different.

Note that, a wireless base station is called an AN (Access Network) while a wireless terminal is called an AT (Access Terminal) in a UMB system. Hereinafter, a wireless base station is termed as an AN as appropriate while a wireless terminal is termed as an AT as appropriate.

In the first embodiment, the wireless terminal 2 requests connection to the wireless base station 1A when power is turned on or handover is to be performed. Specifically, the wireless terminal 2 compares reception qualities of the pilot signals respectively transmitted from the wireless base stations 1A to 1C. The wireless terminal 2 then determines that the wireless quality offered by the wireless base station 1A is the highest and thus transmits a Route_Open message to the wireless base station 1A.

It is assumed here that the wireless quality offered to the wireless terminal 2 by the wireless base station 1B and the wireless quality offered to the wireless terminal 2 by the wireless base station 1C also satisfy a predetermined quality level required to allow the wireless terminal 2 to be connected thereto.

### (1.2) Configuration of Wireless Base Station

Next, a description will be given of a configuration of the wireless base stations 1A to 1C in the order of (1.2.1) Schematic Configuration of Wireless Base Station and (1.2.2) Detailed Configuration of Wireless Base Station.

However, the schematic configuration of the wireless base stations 1B and 1C is the same as that of the wireless base station 1A. Thus, the description of the schematic configuration of the wireless base stations 1B and 1C is omitted herein.

### (1.2.1) Schematic Configuration of Wireless Base Station

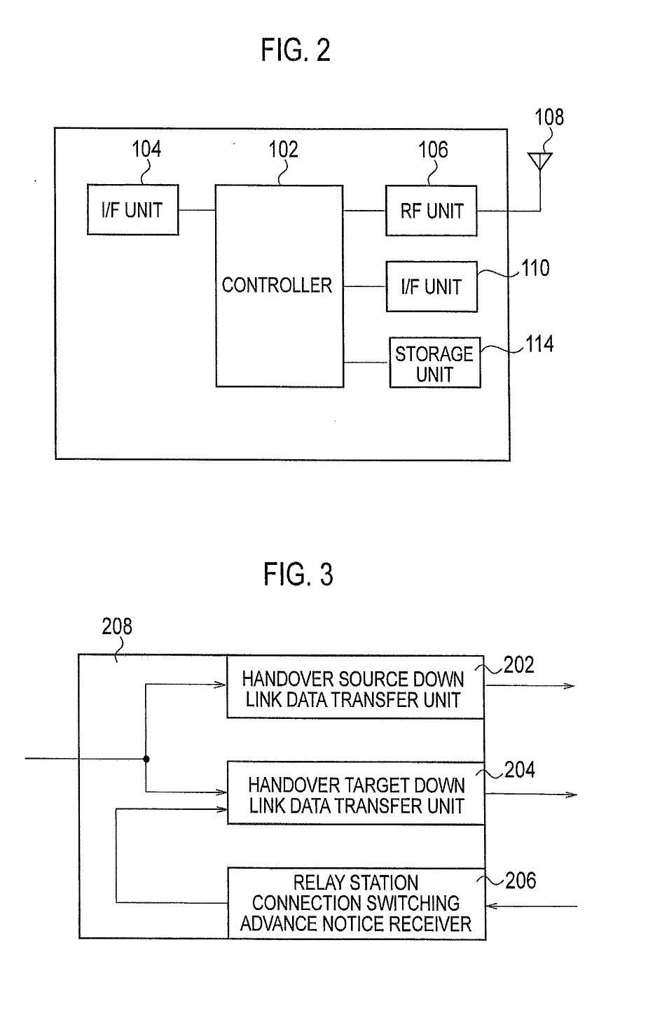

FIG. 2 is a schematic configuration diagram of the wireless base station 1A. As shown in FIG. 2, the wireless base station 1A includes a controller 102, an I/F unit 104, an RF unit 106, an antenna 108, an I/F unit 110, and a storage unit 114.

The controller 102 is configured of a CPU, for example, and controls various functions included in the wireless base station 1A. In addition, the controller 102 has a function to manage a wireless terminal in communication with the wireless base station 1A. Specifically, the controller 102 manages: a wireless terminal using the wireless base station 1A as a DAP; a wireless terminal using the wireless base station 1A as an FLSE; and a wireless terminal using the wireless base station 1A as an RLSE and then causes the storage unit 114 to store information on these wireless terminals.

The I/F unit 104 is wire-connected to the access gateway 3 via a router or the like.

The RF unit 106 includes an LNA, a power amplifier, an up-converter, a down-converter, and the like and performs transmission and reception of a wireless signal via the antenna 108. In addition, the RF unit 106 always broadcasts a pilot signal via the antenna 108.

The I/F unit 110 is wire-connected to the wireless base station 1A and the wireless base station 1C via a router or the like and the wired network 5.

The storage unit 114 is configured of a memory, for example, and stores various information used in control or the like in the wireless base station 1A.

### (1.2.2) Detailed Configuration of Wireless Base Station

Next, a description will be given of a detailed configuration of the wireless base stations 1A to 1C, i.e., a functional block configuration of the controller 102. FIG. 3 is a functional block configuration diagram of the controller 102 in the wireless base station 1A, which is the DAP.

As shown in FIG. 3, the controller 102 includes a handover source down link data transfer unit 202, a handover target down link data transfer unit 204, and a relay station connection switching advance notice receiver 206.

The handover source down link data transfer unit 202 and the handover target down link data transfer unit 204 receive down link data from the upper layer network 4. Further, the handover source down link data transfer unit 202 transfers the received down link data to the wireless base station 1B, which is the Source FLSE.

The relay station connection switching advance notice receiver 206 receives an FLSE switching advance notice, which is a connection switching advance notice from the wireless base station 1B and outputs the received notice to the handover target down link data transfer unit 204.

Upon receipt of the FLSE switching advance notice, the handover target down link data transfer unit 204 stops the handover source down link data transfer unit 202 from transferring the down link data. Further, the handover target down link data transfer unit 204 transfers the down link data from the upper layer network 4 to the wireless base station 1C, which is the Target FLSE. Specifically, the transfer destination of the down link data is switched from the wireless base station 1B to the wireless base station 10.

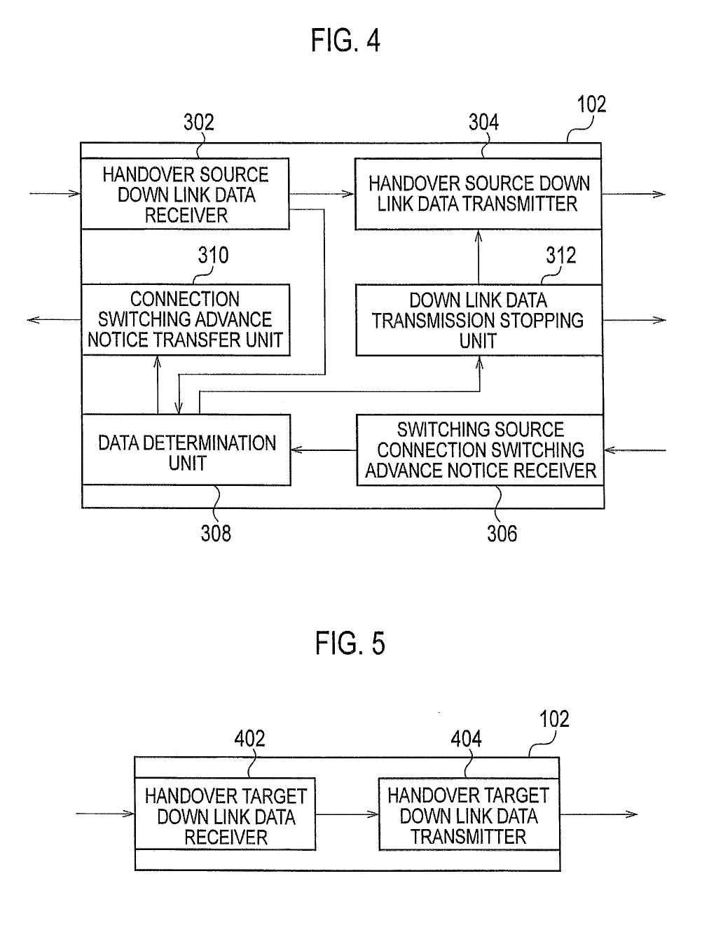

FIG. 4 is a functional block configuration diagram of the controller 102 in the wireless base station 1B, which is the Source FLSE.

As shown in FIG. 4, the controller 102 includes a handover source down link data receiver 302, a handover source down link data transmitter 304, a switching source connection switching advance notice receiver 306, a data determination unit 308, a connection switching advance notice transfer unit 310, and a down link data transmission stopping unit 312.

The handover source down link data receiver 302 receives down link data from the wireless base station 1A. Further, the handover source down link data receiver 302 outputs the received down link data to the handover source down link data transmitter 304 and the data determination unit 308.

The handover source down link data transmitter 304 receives the down link data. Further, the handover target down link data transmitter 404 adds a destination header indicating the wireless base station 1B to the down link data and then transmits the down link data to the wireless terminal 2.

The switching source connection switching advance notice receiver 306 receives an FLSE switching advance notice from the wireless terminal 2. Further, the switching source connection switching advance notice receiver 306 outputs the received FLSE switching advance notice to the data determination unit 308.

The data determination unit 308 receives the down link data from the handover source down link data receiver 302. In addition, the data determination unit 308 receives the FLSE switching advance notice from the switching source connection switching advance notice receiver 306. Further, the data determination unit 308 determines whether or not the received down link data is VoIP (Voice over IP) data. Here, the VoIP data is sound data that requires real-time processing.

When the down link data is VoIP data, the data determination unit 308 outputs the FLSE switching advance notice to the connection switching advance notice transfer unit 310. In addition, the data determination unit 308 instructs the down link data transmission stopping unit 312 to stop the transmission of the down link data.

The connection switching advance notice transfer unit 310 receives the down link data from the data determination unit 308 and transfers the down link data to the wireless base station 1A.

On the basis of the instruction from the data determination unit 308, the down link data transmission stopping unit 312 stops the handover source down link data transmitter 304 from transmitting the down link data to the wireless terminal 2.

FIG. 5 is a functional block configuration diagram of the controller 102 in the wireless base station 1C, which is the Target FLSE.

As shown in FIG. 5, the controller 102 includes a handover target down link data receiver 402 and a handover target down link data transmitter 404.

The handover target down link data receiver 402 receives down link data from the wireless base station 1A. Further, the handover target down link data receiver 402 outputs the received down link data to the handover target down link data transmitter 404.

The handover target down link data transmitter 404 receives the down link data. Further, the handover target down link data transmitter 404 adds a destination header indicating the wireless base station 1C to the down link data and then transmits the down link data to the wireless terminal 2.

### (1.3) Configuration of Wireless Terminal

Next, a description will be given of a configuration of the wireless terminal 2 in the order of (1.3.1) Schematic Configuration of Wireless Terminal and (1.3.2) Detailed Configuration of Wireless Terminal.

### (1.3.1) Schematic Configuration of Wireless Terminal

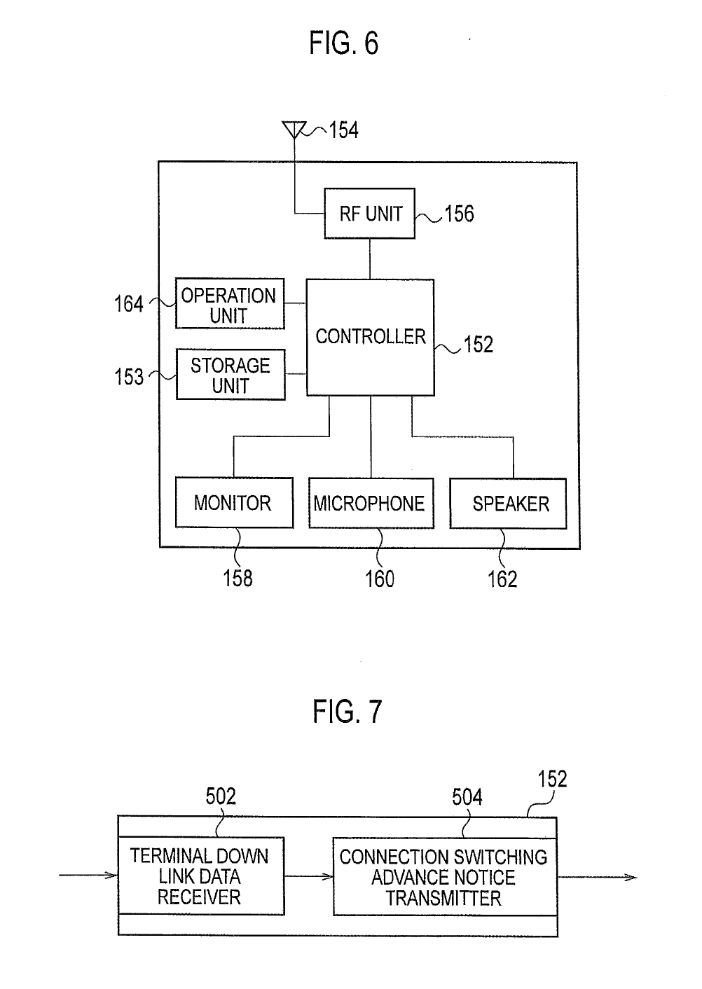

FIG. 6 is a schematic configuration diagram of the wireless terminal 2. As shown in FIG. 6, the wireless terminal 2 includes a controller 152, a storage unit 153, an antenna 154, an RF unit 156, a monitor 158, a microphone 160, a speaker 162, and an operation unit 164.

The controller 152 is configured of a CPU, for example, and controls various functions included in the wireless terminal 2. The storage unit 153 is configured of a memory, for example, and stores various information pieces used in control or the like in the wireless terminal 2.

The RF unit 156 includes an LNA, a power amplifier, an up-converter, a down-converter, and the like and performs transmission and reception of a wireless signal via the antenna 154. In addition, the RF unit 156 periodically receives a pilot signal transmitted from the wireless base stations 1A to 1C via the antenna 108.

The monitor 158 displays an image received via the controller 152 or displays operation contents (input phone number, address, and the like). The microphone 160 collects sound and outputs sound data based on the collected sound to the controller 152. The speaker 162 outputs sound on the basis of the sound data acquired from the controller 152.

The operation unit 164 is configured of a ten-key, function keys, and the like, and serves as an interface that the user uses to input the operation contents.

### (1.3.2) Detailed Configuration of Wireless Terminal

Next, a description will be given of a detailed configuration of the wireless terminal 2, i.e., a functional block configuration of the controller 152. FIG. 7 is a functional block configuration diagram of the controller 152. As shown in FIG. 7, the controller 152 includes a terminal down link data receiver 502 and a connection switching advance notice transmitter 504.

The terminal down link data receiver 502 receives down link data from the wireless base stations 1A to 1C. Further, the terminal down link data receiver 502 outputs the received down link data to the connection switching advance notice transmitter 504.

During execution of the handover from the wireless base station 1B to the wireless base station 1C, the terminal down link data receiver 502 receives the down link data from the wireless base station 1B before the handover. Meanwhile, the terminal down link data receiver 502 receives the down link data from the wireless base station 1C after the handover.

The connection switching advance notice transmitter 504 measures a wireless quality (reception SNR, reception RSSI, reception FER, or the like) offered to itself by each of the wireless base stations 1A to 1C by use of a corresponding one of the pilot signals received by the wireless terminal 2. Further, the connection switching advance notice transmitter 504 transmits an FLSE switching advance notice to the wireless base station which is currently connected to the wireless terminal 2 in a case where, among wireless qualities of the wireless base stations 1A to 1C, a wireless quality offered by a wireless base station, which is not the connection destination, exceeds the wireless quality offered by the wireless base station of the connection destination.

### (2) Operation of Wireless Communication System

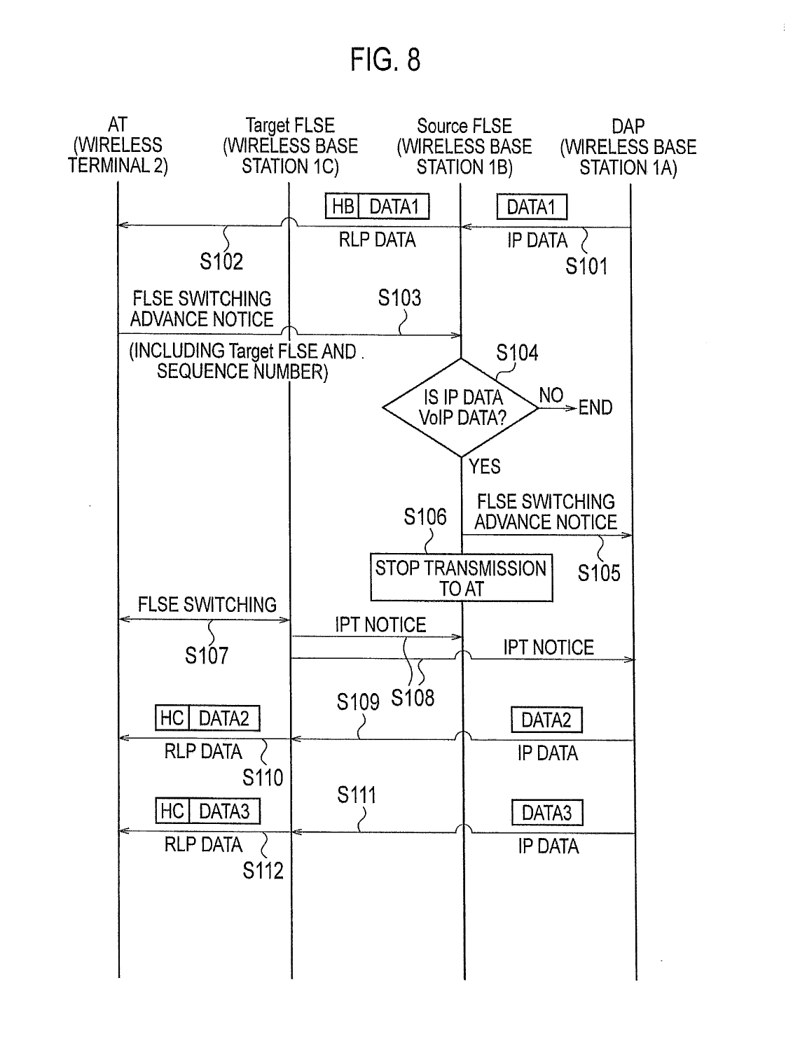

FIG. 8 is a sequence diagram showing an operation of the wireless communication system 10. Here, an assumption is made that the wireless terminal 2 is initially connected to the wireless base station 1B.

In step S101, the wireless base station 1A, which is the DAP, transfers IP data which is down link data to the wireless base station 1B, which is the Source FLSE. The wireless terminal 2 receives the IP data from the wireless base station 1A.

In step S102, the wireless base station 1B adds a destination header indicating the wireless base station 1B to the received IP data and thus generates RLP data as the down link data. Further, the wireless base station 1B transmits the RLP data to the wireless terminal 2. The wireless terminal 2 receives the RLP data from the wireless base station 1B.

Thereafter, in step S103, when a wireless quality offered to the wireless terminal 2 by the wireless base station 1C exceeds a wireless quality offered to the wireless terminal 2 by the wireless base station 1B because of movement of the wireless terminal 2, the wireless terminal 2 transmits an FLSE switching advance notice to the wireless base station 1B. The FLSE switching advance notice includes identification information of the wireless base station 1C, which is the Target FLSE, and also a sequence number that is identification information of the IP data included in the RLP data that the wireless terminal 2 has received lastly. The wireless base station 1B receives the FLSE switching advance notice from the wireless terminal 2.

In step S104, the wireless base station 1B determines whether or not the IP data received in step S101 or the IP data included in the RLP data transmitted in step S103 is VoIP data.

If the IP data is VoIP data, the wireless base station 1B transmits the FLSE switching advance notice to the wireless base station 1A in step S105. The wireless base station 1A receives the FLSE switching advance notice from the wireless base station 1B.

In step S106, the wireless base station 1B stops the transmission of the RLP data to the wireless terminal 2.

Thereafter, the wireless terminal 2 and the wireless base station 1C perform handover (FLSE switching) to switch the connection destination of the wireless terminal 2 from the wireless base station 1B to the wireless base station 1C in step S107.

In step S108, the wireless base station 1C transmits an IPT notice indicating that the handover has been performed, to the wireless base stations 1A and 1B. The wireless base stations 1A and 1B receive the IPT notice from the wireless base station 1C.

In step S109, the wireless base station 1A transfers the IP data, which is the down link data to the wireless base station 1C, which is the Target FLSE. Here, the wireless base station 1A can set the destination of the IP data to the wireless base station 1C on the basis of the identification information of the wireless base station 1C included in the FLSE switching advance notice received in step S105. In addition, the wireless base station 1A performs the transmission of the IP data of a sequence number subsequent to the sequence number included in the FLSE switching advance notice received in step S105. The wireless base station 1C receives the IP data from the wireless base station 1A.

In step S110, the wireless base station 1C adds a destination header indicating the wireless base station 1C to the received IP data and thus generates RLP data. Further, the wireless base station 1C transmits the RLP data to the wireless terminal 2. The wireless terminal 2 receives the RLP data from the wireless base station 1C.

Thereafter, the same operation as the operation performed in steps S109 and S110 is performed. Specifically, the wireless base station 1A transfers the IP data to the wireless base station 1C in step S111. Then, the wireless base station 1C receives the IP data from the wireless base station 1A.

In step S112, the wireless base station 1C adds a destination header indicating the wireless base station 1C to the received IP data and thus generates RLP data. Further, the wireless base station 1C transmits the RLP data to the wireless terminal 2. The wireless terminal 2 receives the RLP data from the wireless base station 1C.

### (3) Advantages and Effects

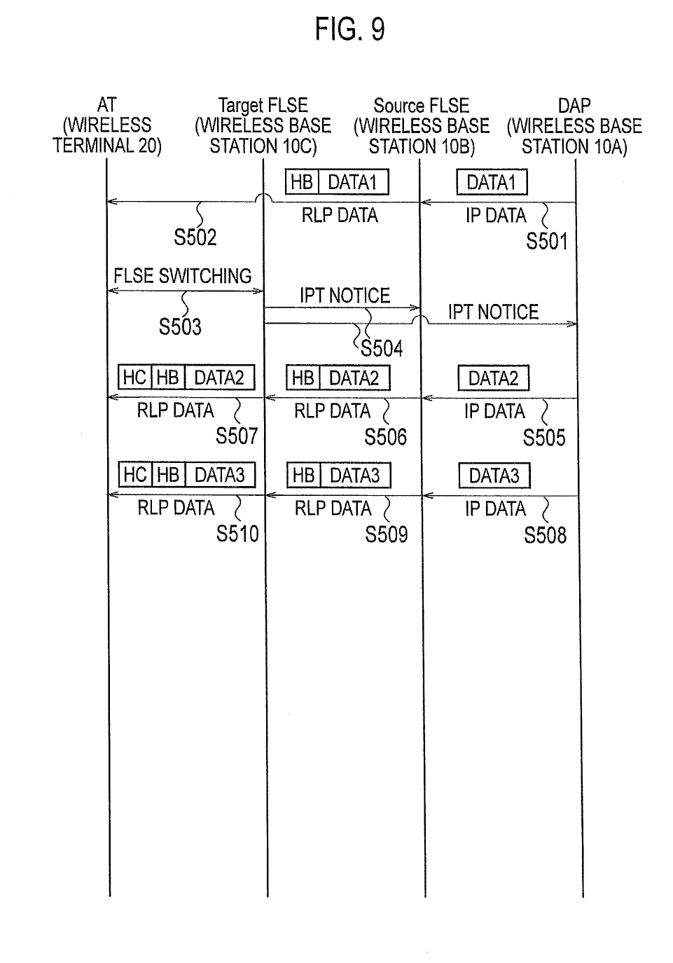

Hereinafter, the operation of the wireless communication system 10 of the first embodiment is compared with an operation of the conventional wireless communication system. FIG. 9 is a sequence diagram showing the operation of the conventional wireless communication system. Here, an assumption is made that a wireless terminal 20 is initially connected to a wireless base station 1B.

In step S501, a wireless base station 1A which is a DAP, transfers IP data, which is down link data, to the wireless base station 1B which is a Source FLSE. The wireless base station 10B then receives the IP data from the wireless base station 1A.

In step S502, the wireless base station 1B adds a destination header indicating the wireless base station 1B to the received IP data and thus generates RLP data as down link data. Further, the wireless base station 1B transmits the RLP data to the wireless terminal 20. The wireless terminal 20 then receives the RLP data from the wireless base station 1B.

Thereafter, the wireless terminal 20 and the wireless base station 1C perform handover (FLSE switching) to switch the connection destination of the wireless terminal 20 from the wireless base station 1B to the wireless base station 1C in step S503.

In step S504, the wireless base station 1C transmits an IPT notice indicating that the handover has been performed, to the wireless base stations 10A and 1B. The wireless base stations 10A and 1B receive the IPT notice from the wireless base station 1C.

In step S506, the wireless base station 1A transfers the IP data to the wireless base station 1B, as in the case of step S501. The wireless base station 1B receives the IP data from the wireless base station 1A.

In step S507, the wireless base station 1A adds a destination header indicating the wireless base station 1C to the received IP data and thus generates RLP data. Further, the wireless base station 1C transmits the RLP data to the wireless base station 10C. The wireless base station 10C receives the RLP data from the wireless base station 1C.

In step S508, the wireless base station 1A adds a destination header indicating the wireless base station 1C to the received RLP data and thus generates new RLP data. Further, the wireless base station 1C transmits the RLP data to the wireless terminal 20. The wireless terminal 20 receives the RLP data from the wireless base station 1C.

Thereafter in steps S508 to S510, the same operation as the operation performed in steps S505 to S507 is performed.

As described above, in the conventional wireless communication system, when the connection destination of the wireless terminal 20 is switched from the wireless base station 10B to the wireless base station 10C, the wireless base station 10A transfers the IP data to the wireless base station 10C via the wireless base station 10B.

On the other hand, according to the wireless communication system 10 of the first embodiment, the wireless base station 1A transfers the IP data, which is down link data from the upper layer network 4, to the wireless base station 1B in a case where the connection destination of the wireless terminal 2 is the wireless base station 1B. Meanwhile, when the wireless base station 1A recognizes, upon receipt of the FLSE switching advance notice from the wireless terminal 2, that the connection destination of the wireless terminal 2 needs to be switched from the wireless base station 1B to the wireless base station 1C, and also that the IP data is VoIP data, the wireless base station 1A switches the transfer destination of the IP data from the wireless base station 1B to the wireless base station 1C. The wireless base station 1A then directly transfers the IP data to the wireless base station 1C by skipping the wireless base station 1B. Accordingly, during the handover, the transfer processing time is reduced, and further, the delay time in the reception of the down link data in the wireless terminal 2 can be reduced.

In addition, in the conventional wireless communication system, the wireless base station 10B adds a destination header to the IP data and transfers the RLP data to the wireless base station 10C. Further, the wireless base station 10C adds a destination header to the RLP data from the wireless base station 10B and transfers the new RLP data to the wireless terminal 20. Specifically, the processing to add a destination header is performed multiple times in the wireless base stations, and multiple destination headers are added to the IP data.

On the other hand, according to the wireless communication system 10 of the first embodiment, the processing to add a destination header in the wireless base station is performed only once. Thus, a reduction in the aforementioned transfer processing time, and further, the delay time in the reception of the down link data in the wireless terminal 2 can be reduced. Moreover, the addition of only one destination header to the IP data makes it possible to prevent the transfer data redundancy, and thus to improve the efficiency in using the transmission path.

In the first embodiment, the wireless base station 1A directly transfers IP data to the wireless base station 1C without the need of the wireless base station 1B only if the IP data being the down link data is VoIP data, which is sound data requiring real-time processing, so that a reduction in the delay time in the reception of the down link data is needed in the wireless terminal 2. Accordingly, when the down link data is VoIP data, the delay time in the reception of the down link data in the wireless terminal 2 can be surely reduced.

In the first embodiment, the FLSE switching advance notice includes the identification information of the wireless base station 1C, which is the Target FLSE, and a sequence number that is the identification information of the IP data included in the RLP data that the wireless terminal 2 has received lastly. Accordingly, the wireless base station 1A can set a destination of the IP data to the wireless base station 1C on the basis of the identification information of the wireless base station 1C included in the received FLSE switching advance notice. In addition, the wireless base station 1A can perform transmission of the IP data of a sequence number subsequent to the sequence number included in the received FLSE switching advance notice, i.e., can perform transmission starting from IP data not yet received by the wireless terminal 2. Thus, efficient transmission is made possible.

### Second Embodiment

Next, a second embodiment of the present invention will be described with reference to the drawings. Specifically, a description will be given of (1) Configuration of Wireless Communication System, (2) Operation of Wireless Communication System, and (3) Advantages and Effects. In the description of the drawings in the embodiments to be described below, the same or similar portions are denoted by the same or similar reference numerals.

### (1) Configuration of Wireless Communication System

To begin with, a description will be given of a configuration of a wireless communication system according to this embodiment. Here, the overall schematic configuration of the wireless communication system and the configuration of the wireless terminal are the same as those of the first embodiment. Thus, the description thereof is omitted herein. In addition, the wireless base stations are the same as those of the fist embodiment. Thus, the description thereof is omitted herein.

### (1.1) Configuration of Wireless Base Station

### (1.1.1) Detailed Configuration of Wireless Base Station

A description will be given of a detailed configuration of wireless base stations 1A and 1B, i.e., a functional block configuration of a controller 102. Here, the detailed configuration of the wireless base station 1C is the same as those of the fist embodiment. Thus, the description thereof is omitted herein.

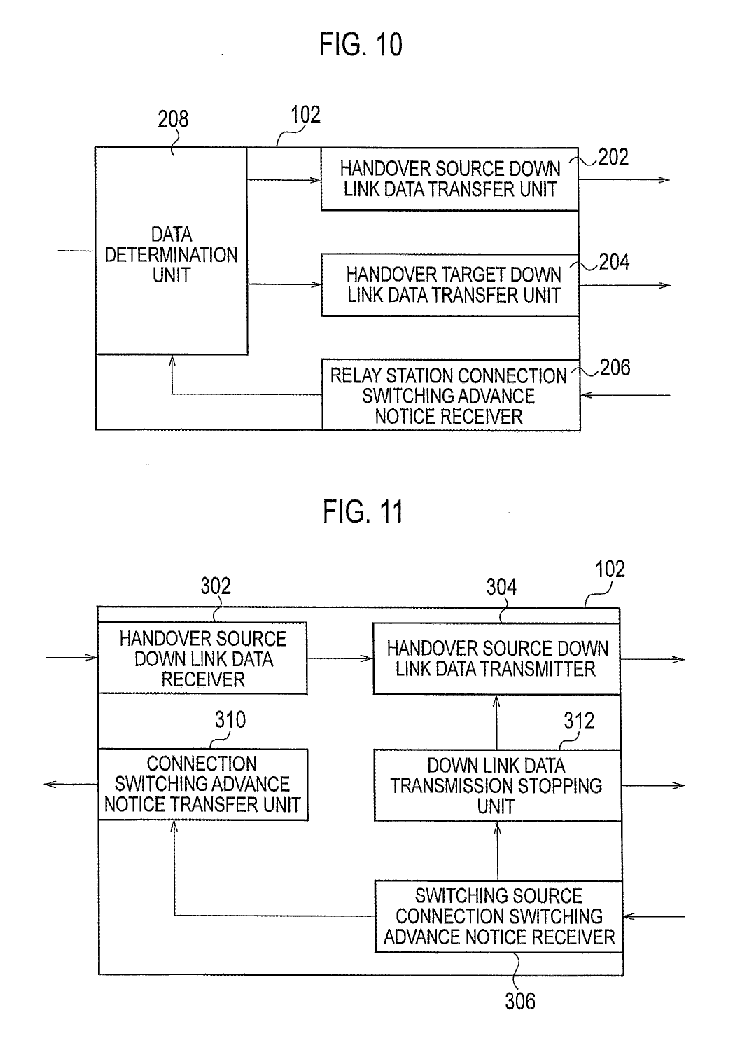

FIG. 10 is a functional block configuration diagram of the controller 102 in the wireless base station 1A which is a DAP. As shown in FIG. 10, the controller 2 includes a handover source down link data transfer unit 202, a handover target down link data transfer unit 204, a relay station connection switching advance notice receiver 206, and a data determination unit 208.

The handover source down link data transfer unit 202 and the handover target down link data transfer unit 204 receive down link data from an upper layer network 4 via the data determination unit 208. Further, the handover source down link data transfer unit 202 transfers the received down link data to the wireless base station 1B which is a Source FLSE.

The relay station connection switching advance notice receiver 206 receives an FLSE switching advance notice from the wireless base station 1B and outputs the notice to the data determination unit 208.

The data determination unit 208 receives down link data from the relay station connection switching advance notice receiver 206. Further, the data determination unit 208 determines whether or not the received down link data is VoIP data.

If the down link data is VoIP data, the data determination unit 208 instructs the handover target down link data transfer unit 204 to switch the transfer destination. On the basis of the instruction from the data determination unit 208, the handover target down link data transfer unit 204 stops the handover source down link data transfer unit 202 from transferring the down link data. Further, the handover target down link data transfer unit 204 transfers the down link data from the upper layer network 4 to the wireless base station 1C which is a Target FLSE. Specifically, the transfer destination of the down link data is switched from the wireless base station 1B to the wireless base station 1C.

FIG. 11 is a functional block configuration diagram of the controller 102 in the wireless base station 1B which is a Source FLSE. As shown in FIG. 11, the controller 102 includes a handover source down link data receiver 302, a handover source down link data transmitter 304, a switching source connection switching advance notice receiver 306, a connection switching advance notice transfer unit 310, and a down link data transmission stopping unit 312.

The handover source down link data receiver 302 receives the down link data from the wireless base station 1A. Further, the handover source down link data receiver 302 outputs the received down link data to the handover source down link data transmitter 304. The handover source down link data transmitter 304 receives the down link data and transmits the down link data to the wireless terminal 2.

The switching source connection switching advance notice receiver 306 receives an FLSE switching advance notice from the wireless terminal 2. Further, the switching source connection switching advance notice receiver 306 outputs the received FLSE switching advance notice to the connection switching advance notice transfer unit 310. In addition, the switching source connection switching advance notice receiver 306 instructs the down link data transmission stopping unit 312 to stop the transmission of the down link data.

The connection switching advance notice transfer unit 310 receives the down link data from the data determination unit 308 and transfers the down link data to the wireless base station 1A.

On the basis of the instruction from the switching source connection switching advance notice receiver 306, the down link data transmission stopping unit 312 stops the handover source down link data transmitter 304 from transmitting the down link data to the wireless terminal 2.

### (2) Operation of Wireless Communication System

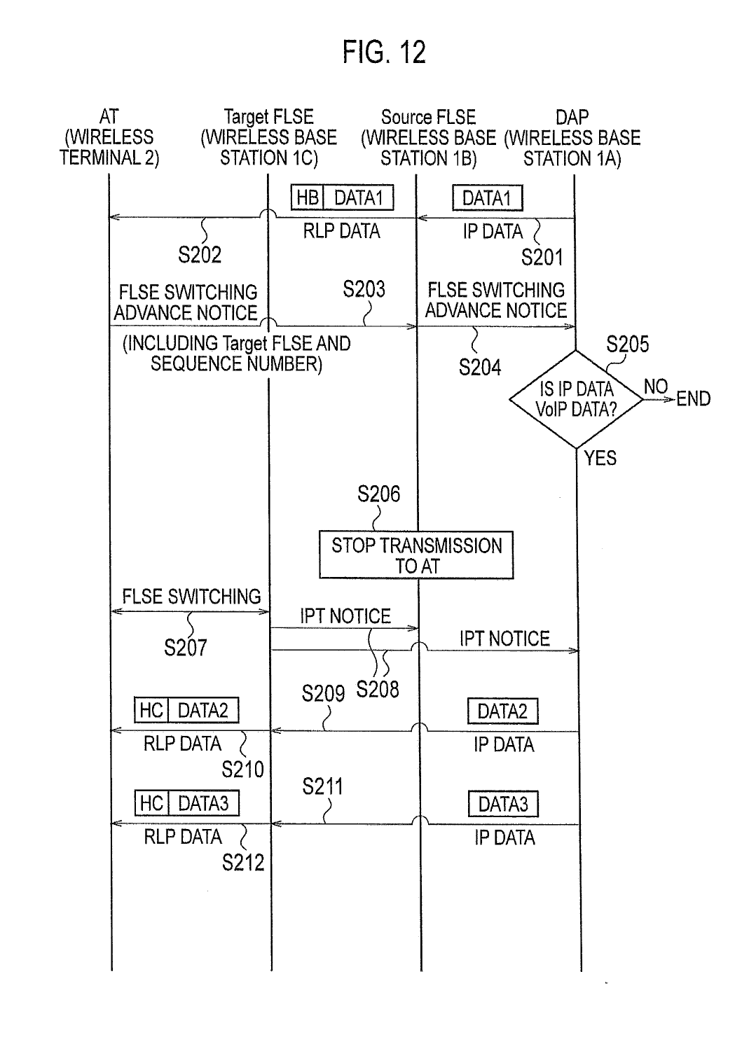

FIG. 12 is a sequence diagram showing an operation of the wireless communication system 10. Here, an assumption is made that the wireless terminal 2 is initially connected to the wireless base station 1B.

The operation from steps S201 to S203 is the same as the operation from steps S101 to S103 of FIG. 8. Thus, the description of the operation is omitted herein.

In step S204, the wireless base station 1B, which is the Source FLSE transmits an FLSE switching advance notice to the wireless base station 1A, which is a DAP. The wireless base station 1A receives the FLSE switching advance notice from the wireless base station 1B.

In step S205, the wireless base station 1A determines whether or not the IP data that the wireless base station 1A has transferred in step S201 is VoIP data.

In step S206, the wireless terminal 2 stops the transmission of the RLP data to the wireless terminal 2.

Thereafter, the wireless terminal 2 and the wireless base station 1C perform handover (FLSE switching) to switch the connection destination of the wireless terminal 2 from the wireless base station 1B to the wireless base station 1C in step S207.

In step S208, the wireless base station 10 transmits an IPT notice indicating that the handover has been performed, to the wireless base stations 1A and 1B. The wireless base stations 1A and 1B receive the IPT notice from the wireless base station 1C.

In step S209, the wireless base station 1A transfers the IP data to the wireless base station 1C, which is the Target FLSE. Here, the wireless base station 1A can set the destination of the IP data to the wireless base station 1C on the basis of the identification information of the wireless base station 1C included in the FLSE switching advance notice received in step S204. In addition, the wireless base station 1A performs the transmission of the IP data of a sequence number subsequent to the sequence number included in the FLSE switching advance notice received in step S204. The wireless base station 1C receives the IP data from the wireless base station 1A.

In step S210, the wireless base station 1C adds a destination header indicating the wireless base station 1C to the received IP data and thus generates RLP data. Further, the wireless base station 1C transmits the RLP data to the wireless terminal 2. The wireless terminal 2 receives the RLP data from the wireless base station 1C.

Thereafter, in steps S211 and S212, the same operation as the operation performed in steps S209 and S110 is performed.

As described above, according to the wireless communication system 10 of the second embodiment, the wireless base station 1A transfers IP data, which is the down link data from the upper layer network 4, to the wireless base station 1B in a case where the connection destination of the wireless terminal 2 is the wireless base station 1B. Meanwhile, when the wireless base station 1A recognizes, upon receipt of the FLSE switching advance notice from the wireless terminal 2, that the connection destination of the wireless terminal 2 needs to be switched from the wireless base station 1B to the wireless base station 1C, and also determines that the IP data is VoIP data, the wireless base station 1A switches the transfer destination of the IP data from the wireless base station 1B to the wireless base station 10. The wireless base station 1A then directly transfers the IP data to the wireless base station without the need of the wireless base station 1B. Accordingly, during the handover, the transfer processing time is reduced, and further, the delay time in the reception of the down link data in the wireless terminal 2 can be reduced.

### Other Embodiment

As described above, the present invention has been described by using the embodiments. However, it should not be understood that the description and drawings which constitute part of this disclosure limit the present invention. From this disclosure, various alternative embodiments, examples, and operation techniques will be easily found by those skilled in the art.

In the aforementioned embodiments, the wireless communication system 10 includes the wireless base stations 1A to 1C. However, the wireless communication system 10 may further include another wireless base station.

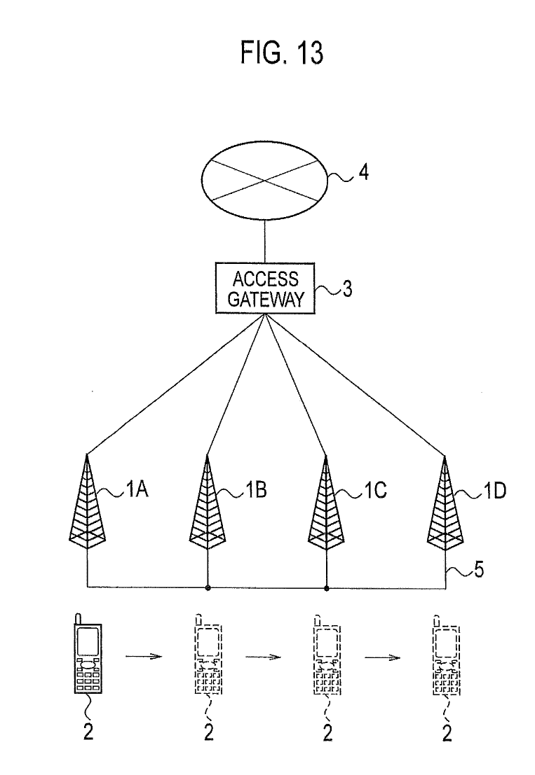

FIG. 13 is an overall schematic configuration diagram of the wireless communication system 10 according to a modification example of the embodiments of the present invention. The wireless communication system 10 shown in FIG. 13 includes a new wireless base station 1D as compared with the wireless communication system 10 shown in FIG. 1.

### (2) Operation of Wireless Communication System

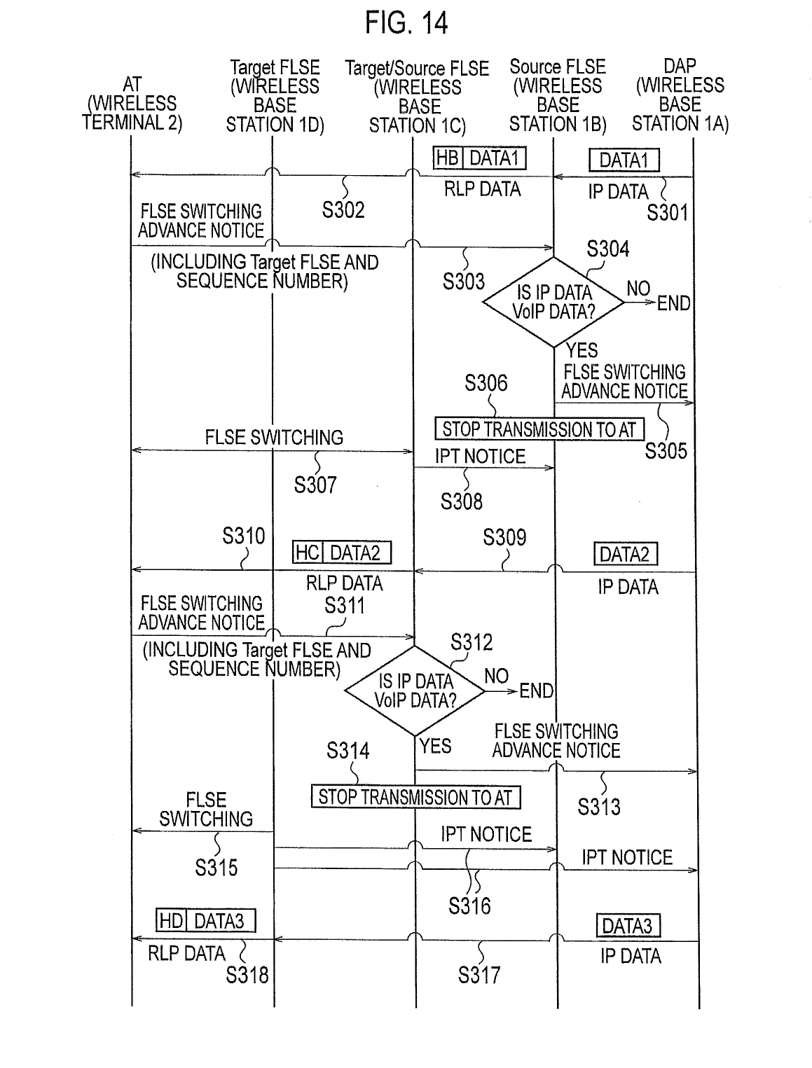

FIG. 14 is a sequence diagram showing an operation of the wireless communication system 10. Here, an assumption is made that the wireless terminal 2 is initially connected to the wireless base station 1B.

The operation from steps S301 to S310 is the same as the operation from steps S101 to S110 of FIG. 8. Thus, the description of the operation is omitted herein.

Thereafter, in step S311, when a wireless quality offered to the wireless terminal 2 by the wireless base station 1C exceeds a wireless quality offered to the wireless terminal 2 by the wireless base station 1B because of movement of the wireless terminal 2, the wireless terminal 2 transmits an FLSE switching advance notice to the wireless base station 1B, which is switched from the Target FLSE to the Source FLSE. The FLSE switching advance notice includes identification information of the wireless base station 1C, which is a new Target FLSE, and also a sequence number that is identification information of the IP data included in the RLP data that the wireless terminal 2 has received lastly. The wireless base station 1B receives the FLSE switching advance notice from the wireless terminal 2.

In step S312, the wireless base station 1B determines whether or not the IP data received in step S309 is VoIP data.

If the IP data is VoIP data, the wireless base station 1B transmits the FLSE switching advance notice to the wireless base station 1A in step S313. The wireless base station 1A receives the FLSE switching advance notice from the wireless base station 1C.

In step S314, the wireless base station 1B stops the transmission of the RLP data to the wireless terminal 2.

Thereafter, the wireless terminal 2 and the wireless base station 1C perform handover (FLSE switching) to switch the connection destination of the wireless terminal 2 from the wireless base station 1B to the wireless base station 1C in step S315.

In step S316, the wireless base station 1C transmits an IPT notice indicating that the handover has been performed, to the wireless base stations 1A and 1B. The wireless base stations 1A and 1B receive the IPT notice from the wireless base station 1C.

In step S317, the wireless base station 1A transfers the IP data, which is the down link data to the wireless base station 1C, which is the Target FLSE. Here, the wireless base station 1A can set the destination of the IP data to the wireless base station 1C on the basis of the identification information of the wireless base station 1C included in the FLSE switching advance notice received in step S313. In addition, the wireless base station 1A performs the transmission of the IP data of a sequence number subsequent to the sequence number included in the FLSE switching advance notice received in step S313. The wireless base station 1C receives the IP data from the wireless base station 1A.

In step S318, the wireless base station 1C adds a destination header indicating the wireless base station 1C to the received IP data and thus generates RLP data. Further, the wireless base station 1C transmits the RLP data to the wireless terminal 2. The wireless terminal 2 receives the RLP data from the wireless base station 1C.

Note that, in the aforementioned embodiments, the configuration based on the UMB system is described. However, the present invention is limited to the UMB system and is applicable to any wireless communication system as long as the wireless communication system employs a configuration in which at least down link data is transferred between wireless base stations during handover of a wireless terminal.

For example, the present invention is applicable in a wireless communication system employing a system such as LTE (Long Term Evolution), which is in the process of standardization in 3GPP (Third Generation Partnership Project). In an LTE wireless communication system, X2 connection is established between wireless base stations.

Then, in a case where the connection destination of a wireless terminal is a wireless base station corresponding to the handover source wireless base station, a wireless base station corresponding to the relay wireless base station transfers down link data from an upper layer network to the wireless base station corresponding to the handover source wireless base station via the X2 connection. Then, in a case where the connection destination of the wireless terminal needs to be switched from the wireless base station corresponding to the handover source wireless base station to a wireless base station corresponding to the handover target wireless base station, and also, the down link data is specific data, the wireless base station corresponding to the relay wireless base station switches the transfer destination of the down link data from the wireless base station corresponding to the handover source wireless base station to the wireless base station corresponding to the handover target wireless base station. The wireless base station corresponding to the relay wireless base station then transfers the down link data to the wireless base station corresponding to the handover target wireless base station via the X2 connection.

Further, upon receipt of the down link data from the wireless base station corresponding to the relay wireless base station, the wireless base station corresponding to the handover source wireless base station transmits the down link data to the wireless terminal.

Meanwhile, upon receipt of the down link data from the wireless base station corresponding to the relay wireless base station, the wireless base station corresponding to the handover target wireless base station transmits the down link data to the wireless terminal.

As described above, it should be understood that the present invention includes various embodiments which are not described herein. Accordingly, the present invention should be limited only by the matters to define the invention in the scope of claims regarded as appropriate based on the disclosure.

Note that, the entire contents of Japanese Patent Application No. 2008-249879 (filed on Sep. 29, 2008) are incorporated in this description by reference.

### INDUSTRIAL APPLICABILITY

As described above, the wireless communication system, the wireless base station, the wireless terminal, and the wireless communication method according to the present invention are advantageous as a wireless communication system and the like because they are capable of reducing the delay time in the reception of down link data in the wireless terminal.

1. A wireless communication system comprising:
a wireless terminal;
a relay wireless base station configured to relay down link data addressed to the wireless terminal from an upper layer network;
a switching source wireless base station which is a handover origin in a case where a connection destination of the wireless terminal is to be switched, and
a switching destination wireless base station which is a handover destination in a case where the connection destination of the wireless terminal is to be switched, wherein
the relay wireless base station includes:
a handover source down link data transfer unit configured to transfer the down link data from the upper layer network to the handover source wireless base station in a case where the connection destination of the wireless terminal is the handover source wireless base station; and
a handover target down link data transfer unit configured to switch a transfer destination of the down link data from the handover source wireless base station to the handover target wireless base station and then to transfer the down link data to the handover target wireless base station in a case where the connection destination of the wireless terminal needs to be switched from the handover source wireless base station to the handover target wireless base station, and also where the down link data is specific data,
the handover source wireless base station includes:
a handover source down link data receiver configured to receive the down link data from the relay wireless base station; and
a handover source down link data transmitter configured to transmit the down link data received by the handover source down link data receiver to the wireless terminal,
the handover target wireless base station includes:
a handover target down link data receiver configured to receive the down link data from the relay wireless base station; and
a handover target down link data transmitter configured to transmit the down link data received by the handover target down link data receiver to the wireless terminal, and
the wireless terminal includes a terminal down link data receiver configured to receive the down link data from at least any of the handover source wireless base station and the handover target wireless base station.

2. The wireless communication system according to claim 1, wherein
the wireless terminal includes a connection switching advance notice transmitter configured to transmit a connection switching advance notice to the handover source wireless base station, the connection switching advance notice announcing in advance that the connection destination will be switched from the handover source wireless base station to the handover target wireless base station,
the handover source wireless base station includes:
a switching source connection switching advance notice receiver configured to receive the connection switching advance notice from the wireless terminal;
a data determination unit configured to determine whether or not the down link data is the specific data in a case where the switching source connection switching advance notice receiver receives the connection switching advance notice;
a connection switching advance notice transfer unit configured to transfer the connection switching advance notice received by the switching source connection switching advance notice receiver to the relay wireless base station in a case where the data determination unit determines that the down link data is the specific data;
a down link data transmission stopping unit configured to stop transmission of the down link data to the wireless terminal in a case where the data determination unit determines that the down link data is the specific data,
the relay wireless base station includes a relay station connection switching advance notice receiver configured to receive the connection switching advance notice from the handover source wireless base station, and
the handover target down link data transfer unit switches the transfer destination of the down link data from the handover source wireless base station to the handover target wireless base station and then transfers the down link data to the handover target wireless base station in a case where the relay station connection switching advance notice receiver receives the connection switching advance notice.

3. The wireless communication system according to claim 1, wherein
the wireless terminal includes a connection switching advance notice transmitter configured to transmit a connection switching advance notice to the handover source wireless base station, the connection switching advance notice announcing in advance that the connection destination is to be switched from the handover source wireless base station to the handover target wireless base station,
the handover source wireless base station includes:
a switching source connection switching advance notice receiver configured to receive the connection switching advance notice from the wireless terminal;
a connection switching advance notice transfer unit configured to transfer the connection switching advance notice received by the switching source connection switching advance notice receiver to the relay wireless base station; and
a down link data transmission stopping unit configured to stop transmission of the down link data to the wireless terminal in a case where the connection switching advance notice is transferred by the connection switching advance notice transfer unit,
the relay wireless base station includes:
a relay station connection switching advance notice receiver configured to receive the connection switching advance notice from the handover source wireless base station; and
a data determination unit configured to determine whether or not the down link data is the specific data in a case where the relay station connection switching advance notice receiver receives the connection switching advance notice, and
the handover target down link data transfer unit switches the transfer destination of the down link data from the handover source wireless base station to the handover target wireless base station and then transfers the down link data to the handover target wireless base station in a case where the data determination unit determines that the down link data is the specific data.

4. The wireless communication system according to claim 1, wherein the specific data is data to be handled in real time.

5. The wireless communication system according to claim 4, wherein the specific data is sound data.

6. The wireless communication system according to claim 1, wherein
the connection switching advance notice includes identification information of the handover target wireless base station and identification information of the down link data already received by the wireless terminal, and
the handover target down link data transfer unit transfers the down link data not yet received by the wireless terminal to the handover target wireless base station on the basis of the identification information of the handover target wireless base station and the identification information of the down link data already received by the wireless terminal.

7. A wireless base station configured to transmit down link data addressed to a wireless terminal from an upper layer network to the wireless terminal via a handover source wireless base station and a handover target wireless base station which are other wireless base stations to connect to the wireless terminal, the wireless base station comprising:
a handover source down link data transfer unit configured to transfer the down link data from the upper layer network to the handover source wireless base station in a case where a connection destination of the wireless terminal is the handover source wireless base station; and
a handover target down link data transfer unit configured to switch a transfer destination of the down link data from the handover source wireless base station to the handover target wireless base station and then transfer the down link data to the handover target wireless base station in a case where the connection destination of the wireless terminal needs to be switched from the handover source wireless base station to the handover target wireless base station, and also where the down link data is specific data.

8. A wireless base station which is configured to perform communication with a wireless terminal and which is a handover origin in a case where a connection destination of the wireless terminal is to be switched, the wireless base station comprising:
a handover source down link data receiver configured to receive down link data addressed to the wireless terminal and transmitted from an upper layer network via a relay wireless base station which is another wireless base station;
a handover source down link data transmitter configured to transmit the down link data received by the handover source down link data receiver to the wireless terminal;
a switching source connection switching advance notice receiver configured to receive a connection switching advance notice from the wireless terminal, the connection switching advance notice announcing in advance that the connection destination of the wireless terminal will be switched to a handover target wireless base station which is another wireless base station;
a data determination unit configured to determine whether the down link data is the specific data in case where the switching source connection switching advance notice receiver receives the connection switching advance notice;
a connection switching advance notice transfer unit configured to transfer the connection switching advance notice to the relay wireless base station in a case where the data determination unit determines that the down link data is the specific data; and
a down link data transmission stopping unit configured to stop transmission of the down link data to the wireless terminal in a case where the data determination unit determines that the down link data is the specific data.

9. A wireless base station which is configured to perform communication with a wireless terminal and which is a handover origin in a case where a connection destination of the wireless terminal is to be switched, the wireless base station comprising:
a handover source down link data receiver configured to receive down link data addressed to the wireless terminal and transmitted from an upper layer network via a relay wireless base station which is another wireless base station;
a handover source down link data transmitter configured to transmit the down link data received by the handover source down link data receiver to the wireless terminal;
a switching source connection switching advance notice receiver configured to receive a connection switching advance notice from the wireless terminal, the connection switching advance notice announcing in advance that the connection destination of the wireless terminal will be switched to a handover target wireless base station which is another wireless base station;
a connection switching advance notice transfer unit configured to transfer the connection switching advance notice received by the switching source connection switching advance notice receiver to the relay wireless base station; and
a down link data transmission stopping unit configured to stop transmission of the down link data to the wireless terminal in a case where the connection switching advance notice transfer unit transfers the connection switching advance notice.

10. A wireless terminal configured to connect to a wireless base station transmitting down link data transferred from an upper layer network via another wireless base station and to perform communication with the wireless base station in connection, the wireless terminal comprising:
a terminal down link data receiver configured to receive the down link data from the wireless base station; and
a connection switching advance notice transmitter configured to transmit a connection switching advance notice to the wireless base station, the connection switching advance notice requesting switching of a connection destination, wherein
the connection switching advance notice includes identification information of the handover target wireless base station and identification information of the down link data already received by the wireless terminal.

11. A wireless communication method in a wireless communication system including: a wireless terminal; a relay wireless base station configured to relay down link data addressed to the wireless terminal from an upper layer network; a handover source wireless base station which is a handover origin in a case where a connection destination of the wireless terminal is to be switched; and a handover target wireless base station which is a handover destination in a case where the connection destination of the wireless terminal is to be switched, the method comprising the steps of:
transferring, by the relay wireless base station, the down link data from the upper layer network to the handover source wireless base station in a case where the connection destination of the wireless terminal is the handover source wireless base station;
switching, by the relay wireless base station, a transfer destination of the down link data from the handover source wireless base station to the handover target wireless base station and then to transfer the down link data to the handover target wireless base station in a case where the connection destination of the wireless terminal needs to be switched from the handover source wireless base station to the handover target wireless base station, and also where the down link data is specific data;
receiving, by the handover source wireless base station, the down link data from the relay wireless base station;
transmitting, by the handover source wireless base station, the received down link data to the wireless terminal;
receiving, by the handover target wireless base station, the down link data from the relay wireless base station;
transmitting, by the handover target wireless base station, the received down link data to the wireless terminal; and
receiving, by the wireless terminal, the down link data from at least any of the handover source wireless base station and the handover target wireless base station.
